(19) United States
(12) Patent Application Publication
(10) Pub. No.: US 2005/0123835 A1
(43) Pub. Date: Jun. 9, 2005

(54) Non-aqueous electrolytes having an extended temperature range for battery applications

(76) Inventor: Luying Sun, Randolph, NJ (US)

Correspondence Address: Patrick H. Higgins;Mathews, Collins, Shepherd & McKay, Suite 306, 100 Thanet Circle, Princeton, NJ, 08540, US

(21) Appl. No.: 10/731,268

(22) Filed: Dec. 9, 2003

(51) Int. Cl. H01M 10/40; H01M 4/52; H01M 4/50; H01M 4/58

(52) U.S. Cl. 429/326; 429/330; 429/339; 429/231.3; 429/231.1; 429/223; 429/221; 429/224; 429/231.8

(57) ABSTRACT

The present invention discloses non-aqueous electrolytes having an extended temperature range for battery applications. The electrolyte comprises an electrolyte salt, e.g. LiPF₆, a first non-aqueous solvent, and a second non-aqueous solvent having a structure of formula I or II. The electrolyte of the present invention has higher ionic conductivity, lower freezing point, and lower vapor pressure at high temperature than commercial electrolytes. These non-aqueous electrolytes can be used, for example, in lithium-ion batteries. Methods of making lithium-ion batteries are also described.

### FIELD OF THE INVENTION

The present invention relates generally to non-aqueous electrolytes and their use in making batteries, capacitors, fuel cells, sensors, electrochromic devices, and the like.

### BACKGROUND OF THE INVENTION

Since the commercialization of the first liquid lithium-ion battery “LLB” by Sony in the early 1990's, the world wide market for LLB has tripled over the last ten years. The lithium-ion batteries have been used as mobile power sources for such devices as cellular phones, notebook computers, hybrid electric vehicles (HEV), and also specialty devices for military use. Both consumer and specialty markets have a trend towards more energy density, larger size and thinner battery.

A lithium-ion rechargeable battery comprises a negative electrode, a positive electrode, a battery separator membrane, and a non-aqueous electrolyte which provides the medium for the movement of ions between electrodes during charge or discharge cycle.

Commercial lithium-ion batteries generally use solutions of a lithium salt, such as LiPF₆ in organic solvents including ethylene carbonate “EC”, diethyl carbonate “DEC”, dimethyl carbonate “DMC”, and ethyl methyl carbonate “EMC” (see, e.g., Linden, D. Ed., Handbook of Batteries, third Edition, p. 35.21, McGraw-Hill, N.Y., 2002).

Some patents have generically discussed the possible presence of nitrile components in electrolytes. For example, U.S. Pat. No. 4,544,615 issued to Shishikura et al discloses a battery comprising electrodes made of polymers having conjugated double bonds and an electrolytic solution comprising an electrolyte and an organic solvent being a nitrile compound.

U.S. Pat. No. 4,879,192 issued to Nishimura et al describes a 2.5V polymer secondary cell comprising electrodes, an electrolyte dissolved in a nitrile compound, and also radical scavengers or adsorbents to prevent destruction of the conjugated double bonds; U.S. Pat. No. 6,535,373 issued to Smith et al discloses an electrolyte consisting of at least two quaternary ammonium salts in a nitrile solvent; U.S. Pat. No. 5,418,682 issued to Warren, Jr. et al describes a capacitor having an electrolyte containing a mixture of dinitriles; U.S. Pat. No. 4,882,244 issued to Donahue et al describes an acidic electrolyte comprising a Lewis acid and a nitrile compound; D.E. Pat. No. 102 09 429 issued to Ulrich et al discloses a lithium bis(oxalato)borate based electrolyte containing three kinds of solvent including dinitriles; U.S. Pat. No. 3,945,848 issued to Dey et al; and U.S. Pat. No. 3,098,770 issued to Horowitz et al.

The commercial lithium-ion batteries can generally be used in a temperature range from −20° C. to +60° C. These batteries can not be operated properly outside of this temperature range due to either poor conductivity of electrolyte at low temperature or battery swelling at high temperature. Moreover, if the operating temperature is too high, the internal pressure of the batteries will be too high to be operated safely. Therefore, there is a need to create an improved electrolyte with a wider temperature range for battery applications.

### SUMMARY OF THE INVENTION

Accordingly, it is one objective of this invention to provide an advanced non-aqueous electrolyte having an extended temperature range for battery applications.

It is another objective of this invention to provide a non-aqueous electrolyte that is electrochemically stable up to at least about 4.2V.

It is another objective of this invention to provide a non-aqueous electrolyte that has low vapor pressure at a temperature of about 90° C. or higher.

It is another objective of this invention to provide a non-aqueous electrolyte that has high ionic conductivity, in particular, at a temperature of about −30° C. or lower.

It is another objective of this invention to provide a non-aqueous electrolyte that is suitable for making lithium-ion batteries.

It is another objective of this invention to provide a lithium-ion battery that has wider temperature range for applications than conventional lithium-ion batteries.

It is another objective of this invention to provide a lithium-ion battery that has an improved safety feature than conventional lithium-ion batteries.

It is another objective of this invention to provide a nitrile that is compatible with electrolyte salts, such as LiPF₆.

It is another objective of this invention to provide a specific nitrile that can be used together with LiPF₆ in formulating electrolyte. The resulting electrolyte is electrochemically stable up to at least about 4.2V. It has higher ionic conductivity, lower freezing point and higher boiling point, namely lower vapor pressure at an elevated temperature than conventional electrolytes.

The inventor has now surprisingly discovered a novel non-aqueous electrolyte and a battery containing such electrolyte that satisfies the above objects of this invention and other objects which will become apparent from the description of the invention given herein below. The novel non-aqueous electrolyte, which comprises an electrolyte salt e.g. LiPF₆, a first solvent and a second solvent being a nitrile compound selected from the nitrites having a particular chemical structure, is electrochemically stable up to about 4.2V and is suitable for high-voltage battery such as lithium-ion batteries. The novel non-aqueous electrolyte has showed an extended temperature range for battery applications.

The non-aqueous electrolyte of the present invention comprises: (1) an electrolyte salt, and (2) a first non-aqueous solvent, and (3) a second non-aqueous solvent being at least one of the nitrile compounds represented by the following general formula (I) and (II): 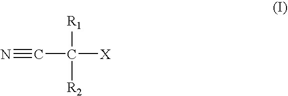
wherein R₁, R₂ are selected, independent of one another, from the group consisting of hydrogen, C₁₋₃ alkyl, fluorinated C₁₋₃ alkyl groups; wherein X is selected from ether radical having a chemical structure of —O—R₃, ester radical having a chemical structure of 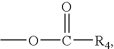
and carbonate radical having a chemical structure of 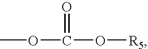
wherein R₃, R₄, R₅ are selected, independent of one another, from the group consisting of C₁₋₃ alkyl and fluorinated C₁₋₃ alkyl, and 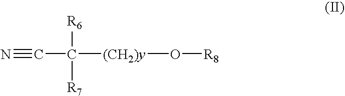
wherein R₆, R₇ are selected, independent of one another, from the group consisting of hydrogen, C₁₋₃ alkyl, fluorinated C₁₋₃ alkyl groups; Y stands an integer of 1 and 2; R₈ is selected from the group consisting of C₁₋₃ alkyl and fluorinated C₁₋₃ alkyl.

Another aspect of the invention is directed to a lithium-ion battery comprising (1) at least one positive electrode made of lithiated metal oxide selected from the group consisting of LiCoO₂, LiNiO₂, LiMn₂O₄, and LiFeFO₄, (2) at least one negative electrode made of carbonaceous material selected from the group consisting of coke and graphite, (3) a separator membrane, and (4) a non-aqueous electrolyte which comprises (i) an electrolyte salt, (ii) a first non-aqueous solvent, and (iii) a second non-aqueous solvent being at least one of the nitrile compounds represented by the following general formula (I) and (II) as described above.

A further aspect of the invention is directed to a method of making a lithium-ion battery, comprising the steps of (a) assembling the battery by sandwiching at least one separator membrane between at least a positive electrode and a negative electrode, (b) packaging the assembled battery cell into a battery case, (c) preparing non-aqueous electrolyte containing (i) at least one electrolyte salt selected from the group consisting of LiPF₆, LiBF₄, LiAsF₆, LiCl₄, LiN(SO₂CF₃)₂, and lithium perfluoro-sulfonates (therefore including combinations thereof), (ii) at least one first non-aqueous solvent selected from the group consisting of cyclic carbonate, linear carbonate, ester, and ether (therefore including combinations thereof), and (iii) a second non-aqueous solvent being at least one of the nitrile compounds represented by the following general formula (I) and (II) as described above, and (d) adding the non-aqueous electrolyte into the battery case.

Various publications are cited in the present application, including, but not limited to, Shishikura et al, U.S. Pat. No. 4,544,615; Nishimura et al, U.S. Pat. No. 4,879,192; Smith et al, U.S. Pat. No. 6,535,373; Warren, Jr. et al, U.S. Pat. No. 5,418,682; Donahue et al, U.S. Pat. No. 4,882,244; Ulrich et al, D.E. Pat. No. 102 09 429; Dey et al, U.S. Pat. No. 3,945,848; Horowitz et al, U.S. Pat. No. 3,098,770; and Jinno et al, Japanese Patent Publication (Jpn. Kokai Tokkyo Koho) No. 08321312. The contents of these publications and the contents of documents cited in these publications are hereby incorporated herein by reference.

### BRIEF DESCRIPTION OF THE DRAWINGS

FIG. 1 shows charge-discharge voltage profile of a battery made using the non-aqueous electrolyte of Sample No. E-5.

FIG. 2 is a graph showing a comparison of the voltage curves of three batteries made using the electrolyte Sample Nos. CE-4 (circle), E-2 (triangle), and E-4 (square) during first charge cycle.

FIG. 3 shows a comparison of weight loss at 90° C. for the electrolytes of the present invention Sample Nos. E-13 (circle), E-14 (square) and control electrolytes Sample Nos. CE-6 (triangle) and CE-7 (diamond).

FIG. 4 shows discharge profiles at −30° C. of four batteries made with the use of the electrolyte of the present invention Sample Nos. E-14 (Battery No. 1, square) and E-9 (Battery No. 2, diamond), and two control conventional electrolytes Sample Nos. CE-6 (Battery No. 3, triangle) and CE-7 (Battery No. 4, circle).

### DETAILED DESCRIPTION

The non-aqueous electrolyte of this invention has such advantages over conventional electrolytes when used in the manufacture of liquid lithium-ion batteries as lower low-temperature limit and higher high-temperature limit for battery applications, i.e. the electrolyte has an extended temperature window for battery applications. In particular, with an increase of high-temperature limit, the resulting batteries have an improved safety feature.

The non-aqueous electrolyte of the present invention comprises: (1) an electrolyte salt, and (2) a first non-aqueous solvent, and (3) a second non-aqueous solvent being at least one of the nitrile compounds represented by the following general formula (I) and (II): 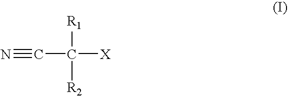
wherein R₁, R₂ are selected, independent of one another, from the group consisting of hydrogen, C₁₋₃ alkyl, fluorinated C₁₋₃ alkyl groups; wherein X is selected from ether radical having a chemical structure of —O—R₃, ester radical having a chemical structure of 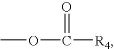
and carbonate radical having a chemical structure of 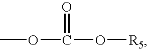
wherein R₃, R₄, R₅ are selected, independent of one another, from the group consisting of C₁₋₃ alkyl, fluorinated C₁₋₃ alkyl, and C₁₋₃ alkyl having a substituent of nitrile radical, and 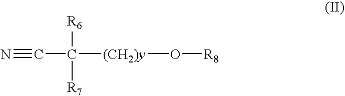
wherein R₆, R₇ are selected, independent of one another, from the group consisting of hydrogen, C₁₋₃ alkyl, fluorinated C₁₋₃ alkyl groups; Y stands an integer of 1 and 2; R₈ is selected from the group consisting of C₁₋₃ alkyl, fluorinated C₁₋₃ alkyl, and C₁₋₃ alkyl having a substituent of nitrile radical.

Examples of these nitrile compounds include 3-methoxypropionitrile “MPN”, 3-ethoxypropionitrile “EPN”, methoxyacetonitrile “MAN”, ethoxyacetonitrle “EAN”, 2-acetoxyisobutyronitrile “ABN”, 2-cyano-isopropyl methyl carbonate “CPMC”, 2-acetoxyacetonitrile “AAN”, 2-acetoxyisopropionitrile “AiPN”, cyanomethyl methyl carbonate “CMMC”, and 1-cyanoethyl methyl carbonate “CiEMC”.

The nitrile is present preferably in an amount of from about 20 to about 95% by weight as of the total of non-aqueous solvent, more preferably from about 25 to about 80%, and the most preferably from about 30 to about 50%.

The freezing point of the nitrile is preferably lower than −20° C., more preferably lower than −40° C., and the most preferably lower than −60° C.

The boiling point of the nitrile is preferably higher than 120° C., more preferably higher than 160° C., and the most preferably higher than 200° C.

The flash point of the nitrile is preferably higher than 30° C., more preferably higher than 60° C., and the most preferably higher than 110° C.

The molecular weight of the nitrile is preferably smaller than 200, more preferably smaller than 90, and the most preferably smaller than 75.

The term “electrolyte salt” generally includes any salt that comprises a cation and an anion, said cation being selected from the group consisting of lithium ion, sodium ion and potassium ion, and said anion being selected from the group consisting of anions of halides of elements of the groups IIIa and Va of the periodic table, halogen anions, and perchloric acid anions.

Examples of these electrolyte salts include LiPF₆, LiBF₄, LiAsF₆, LiCl₄, LiN(SO₂CF₃)₂, lithium perfluoro-sulfonates.

The electrolyte salt is preferably LiPF₆ or LiBF₄, more preferably a mixture of LiPF₆ and LiBF₄ in a molar ratio from about 90:10 to about 50:50.

The first non-aqueous solvent is selected from the group consisting of ethylene carbonate “EC”, propylene carbonate “PC”, diethyl carbonate “DEC”, dimethyl carbonate “DMC”, ethyl methl carbonate “EMC”, γ-butyrolactone “γ-BL”, methyl acetate “MA”, methyl formate “MF”, and dimethyl ether “DME”. Preferably the first non-aqueous solvent is EC or a mixture of EC with DEC, DMC, or EMC.

The first non-aqueous solvent is present preferably in an amount of from about 5 to about 80% by weight as of the total of non-aqueous solvent, more preferably from about 20 to about 70%, and the most preferably from about 20 to about 50%.

The non-aqueous electrolyte of the present invention has high ionic conductivity. The conductivity of the electrolyte is preferably greater than 9×10⁻³ S/cm at about 25° C., greater than 1×10⁻³ S/cm at about −30° C., and greater than 3×10⁻⁴ S/cm at about −50° C.

The non-aqueous electrolyte of the present invention is not volatile. The weight loss is preferably less than 3% when heated at 90° C. for 2 hours, and less than 5% at 90° C. for 4 hours.

An important utility for this non-aqueous electrolyte is in the manufacture of batteries comprising (1) at least one positive electrode, (2) at least one negative electrode, (3) a separator membrane, and (4) a non-aqueous electrolyte.

The negative electrode is usually made of metallic lithium or carboneous material such as coke or graphite. It can also be made from an intercalating metal oxide such as tungsten oxide or iron oxide. The positive electrode can be made of lithium compounds such as LiCoO₂, LiNiO₂, LiMn₂O₄, LiFePO₄, and LiCoₓNi₁₋ₓO₂ wherein the x is from 0.1 to 0.9. Material such as V₆O₁₃, MnO₂, FeS₂, CFₓ (carbon monofluoride) can also be used for making a positive electrode.

The positive electrode and the negative electrode are separated by at least one separator membrane such as (i) a polyolefin based porous polymer membrane, preferably made of polyethylene “PE”, polypropylene “PP”, or a combination of PE and PP, such as a trilayer PP/PE/PP membrane, (ii) heat-activatable microporous membranes as described in U.S. Pat. No. 6,527,955, the contents of which are incorporated herein by reference, (iii) porous materials made of fabric including glass or synthetic fabric (woven or non-woven fabric), (iv) porous membrane made of polymer materials such as poly(vinyl alcohol), poly(vinyl acetate), cellulose, and polyamide, etc.

The following examples are given as specific illustrations of the invention. It should be understood, however, that the invention is not limited to the specific details set forth in the examples. All parts and percentages in the examples, as well as in the remainder of the specification, are by weight unless otherwise specified.

Further, any range of numbers recited in the specification or paragraphs hereinafter describing or claiming various aspects of the invention, such as that representing a particular set of properties, units of measure, conditions, physical states or percentages, is intended to literally incorporate expressly herein by reference or otherwise, any number falling within such range, including any subset of numbers or ranges subsumed within any range so recited. The term “about” when used as a modifier for, or in conjunction with, a variable, is intended to convey that the numbers and ranges disclosed herein are flexible and that practice of the present invention by those skilled in the art using temperatures, concentrations, amounts, contents, carbon numbers, and properties that are outside of the range or different from a single value, will achieve the desired result, namely, a non-aqueous electrolyte and a lithium-ion battery and methods for preparing such electrolyte and battery.

### EXAMPLE 1

### Preparation of Non-Aqueous Electrolyte

A non-aqueous electrolyte was prepared in a dry-box under nitrogen atmosphere which having less than about 1 ppm moisture. 3.0 g of anhydrous acetonitrile “AN” made by Sigma-Aldrich Corp. of Milwaukee, Wis., was mixed in a polypropylene bottle with 12.0 g of a blend of ethylene carbonate “EC” and diethyl carbonate “DEC” which has a 1:1 weight ratio made by Ferro Corp of Zachary, LA. Then, to the mixture was added 1.51 g of LiBF₄ produced by Stella Chemifa Corp. of Osaka, Japan. After stirred for a while, LiBF₄ dissolved completely and resulted in a clear and colorless electrolyte solution which can be expressed as 1.2M LiBF₄EC/DEC/AN 2:2:1. The electrolyte is also summarized in Table 1 as Sample No. E-1.

### Battery Preparation and Test

A lithium-ion rechargeable battery was assembled using a carbon negative electrode, a LiCoO₂ positive electrode, and a commercial battery separator membrane. Into the assembled battery case, was injected the non-aqueous electrolyte of this invention. Both negative and positive electrodes were conventional liquid lithium-ion battery electrodes, namely negative electrode containing about 90% active carbon material, and the positive electrode containing about 91% active LiCoO₂ which were produced by Hitachi Maxell Ltd. of Osaka, Japan.

A Teklon™ (ultra-molecular weight polyethylene) separator membrane made by Entek Membrane LLC of Lebanon, Oreg., with a dimension of 38 mm by 45 mm was sandwiched between a positive electrode 30 mm by 38 mm and a negative electrode 32 mm by 40 mm, i.e. the battery having a total active area of 11 cm². The battery was packaged and partially sealed in an aluminum foil-laminated plastic bag. After the battery was fully dried, it was transferred into a dry-box under nitrogen atmosphere which having less than 1 ppm moisture. About 0.4 g of above electrolyte 1.2M LiBF₄EC/DEC/AN 2:2:1 (Sample No. E-1) was injected into the battery.

The battery was completely sealed, and then was subjected to charge/ discharge performance test and AC impedance measurement. The charge/ discharge performance test was conducted using a Battery Tester Model Series 4000 manufactured by Maccor Inc. of Tulsa, Okla. Two batteries were prepared using this electrolyte. Data concerning these batteries are set forth in Table 2 under the electrolyte Sample No E-1.

The batteries were charged at a constant current of 11 mA up to 4.2V, and then a constant voltage “CV” until the current drops to less than 1.6 mA. They were discharged at various current levels of 6.6, 11, 16.5, 33, 49.5 and 66 mA respectively, namely the C rate was 0.2 C, 0.33 C, 0.5 C, 1 C, 1.5 C and 2 C respectively. In other words, the current density for discharging was 0.6, 1.0, 1.5, 3.0, 4.5 and 6 mA/cm respectively.

As recorded in Table 2, both batteries delivered reasonable capacity (35.59 and 35.46 mAh) and offered good rate capability: over 97% at 1 C and about 90% at 2 C rate.

AC impedance of batteries was measured using an impedance analyzer Parstat 2263 made by Princeton Applied Research of Oak Ridge, Tenn. The batteries were scanned from a high frequency of 500 kHz to 0.1 Hz. Electrolyte resistance “Re” is equal to the intercept of the semi circle at high frequency, and the polarization resistance “Rp” is equal to the intercept segment of the semi circle with the real impedance axis. Both Re and Rp are recorded in Table 2. As indicated in the table, the electrolyte resistances for above two batteries are 0.772 and 0.722 Ω, and the polarization resistances are 2.665 and 2.120 Ω.

### COMPARATIVE EXAMPLE 1

This example is shown in Table 1, Sample No. CE-1, which was prepared using the same procedure and also same materials as described in Example 1 except with a substitution of LiPF₆ produced by Stella Chemifa Corp. of Osaka, Japan, in place of LiBF₄.

In the same manner as described in Example 1, two batteries were made using the electrolyte Sample No CE-1. Testing data of the resulting batteries are recorded in Table 2 under electrolyte Sample No. CE-1. As indicated in the table, these batteries delivered very little discharge capacity (1.82 and 4.57 mAh), and showed extremely poor rate capability and high impedance. These results indicated the electrolyte Sample CE-1, made of acetonitrile and LiPF₆, could not be used for lithium-ion battery due to a side reaction with electrode.

### EXAMPLES 2-5

As summarized in Table 1, Sample Nos. E-2 through E-5, were prepared using the same materials as described in Example 1 except a substitution of 3-methoxypropionitrile “MPN” made by Sigma-Aldrich Corp. of Milwaukee, Wis., in place of AN, and also with different molar ratios of salts LiBF₄ and LiPF₆. The MPN was purified before use by distillation through a column under reduced pressure. Sample No. E-2 was made using LiBF₄, No. E-5 LiPF₆, Nos. E-3 and E-4 a mixture of LiBF₄ and LiPF₆ in a molar ratio of 3:1 and 1:3 respectively.

In the same manner as described in Example 1, two batteries were made for each electrolyte samples (Nos. E-2 through 5). Testing data of the resulting batteries are recorded in Table 2 under each electrolyte sample number. As indicated in the table, in all cases, batteries delivered reasonable capacity (33 mAh). In the cases of the electrolytes Sample Nos. and E-3 and E-4, which was made using a mixture of LiBF₄ and LiPF₆, in particular, Sample No. E-5, made of LiPF₆ alone, resulting batteries showed high rate capability and low impedance.

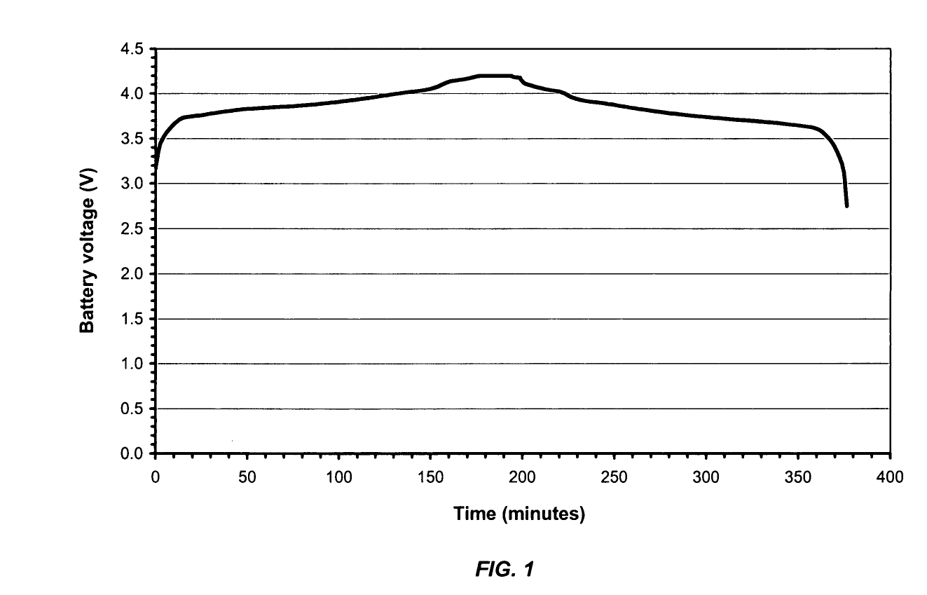

FIG. 1 shows voltage profile of a battery made using electrolyte Sample No. E-5, comprising LiPF₆, MPN and other two carbonate solvents. The battery was charged up to 4.2V and then discharged to an end point of 2.75V at ambient temperature of 23-25° C. No oxidation was showed up from this figure, indicating the electrolyte was electrochemically stable to up 4.2V.

### EXAMPLE 6

This example is shown in Table 1 as Sample No. E-6 was prepared using the same materials as Sample No. E-2 except solvents were present in different weight ratios and also LiBF₄ was present in a higher molar concentration of 2.0M.

In the same manner as described in Example 1, two batteries were made for the electrolyte samples No. E-6. Testing data of the resulting batteries are recorded in Table 2.

### COMPARATIVE EXAMPLE 2

In this example, non-aqueous electrolyte Sample No. CE-2 was made with the same recipe as Sample No. E-2 but without the use of ethylene carbonate “EC” and diethyl carbonate “DEC”, i.e. the resulting electrolyte is 1.2M LiBF₄ MPN with the presence of nitrile solvent alone.

Two batteries were made using electrolyte Sample No. CE-2 in the same manner as described in Example 1. Cycle performance and impedance of the resulting batteries are set forth in Table 2 under the electrolyte Sample No. CE-2. As shown in the table both capacity and rate capability are zero. It is clear that batteries made using an electrolyte comprising nitrile alone could not be charged or discharged.

### EXAMPLE 7

In this instance, a non-aqueous electrolyte Sample No. E-7 was prepared with the same formulation as Sample No. E-4 except with a substitution of 2-acetoxyisobutyronitrile “ABN” for MPN. The ABN was synthesized as follows:

In a 500-ml flask fitted with a nitrogen inlet and equipped with a magnetic stirrer, were placed 34.04 g (0.40 moles) of acetone cyanohydrin, 250 ml of dichloromethane, and 32.97 g (0.42 moles) of acetyl chloride. The flask was cooled to 0-5° C. with ice-water bath and 34.80 g (0.44 moles) of dry pyridine was added in a dropwise manner over about 2 hours under nitrogen atmosphere. Precipitates of pyridine hydrochloride salt formed as pyridine was added. At the conclusion of the addition, the mixture was stirred overnight at room temperature. The mixture was then filtered. The resulting solution was concentrated to about total of 150 ml using a rotary evaporator. Then, it was washed with water four times (4×50 ml) until the pH of the water phase became neutral, and finally washed with brine (saturated aqueous NaCl) once (30 ml). The organic solution was dried with MgSO₄, filtered, and concentrated on a rotary evaporator. The crude product was distilled through a column under reduced pressure. Distillation gave 36.26 g of ABN, yield of 71.3%, b.p. 56.0-58.0° C./4.1 mmHg. The identity of the product was confirmed using ¹H NMR spectroscopy (¹H NMR, CDCl₃/δ: 1.75 (s, 6H, (CH₃)₂—C(CN)—O—); 2.09 (s, 3H, CH₃—COO—).

Two batteries were made using electrolyte Sample No. E-7 in the same manner as described in Example 1. Cycle performance and impedance of the resulting batteries are set forth in Table 2 under the electrolyte Sample No. E-7. As shown in the table the batteries delivered great capacity but showed low rate capability at 2C rate. The low rate capability is probably due to the high molecular weight of ABN which results in less mobility of ions.

### EXAMPLE 8

This example is shown in Table 1 as Sample No. E-8 was prepared with the same formulation as Sample No. E-4 except with a substitution of 2-cyano-isopropyl methyl carbonate “CPMA” for MPN. The CPMA was synthesized as follows:

In a 500-ml flask fitted with a nitrogen inlet and equipped with a magnetic stirrer, were placed 34.04 g (0.40 moles) of acetone cyanohydrin, 250 ml of dichloromethane, and 39.69 g (0.42 moles) of methyl chloroformate. The flask was cooled to 0-5° C. with ice-water bath and 34.80 g (0.44 moles) of dry pyridine was added in a dropwise manner over about 2 hours under nitrogen atmosphere. Precipitates of pyridine hydrochloride salt formed as pyridine was added. At the conclusion of the addition, the mixture was stirred overnight at room temperature. The mixture was then filtered. The resulting solution was concentrated to about total of 150 ml using a rotary evaporator. Then, it was washed with water four times (4×50 ml) until the pH of the water phase became neutral, and finally washed with brine (saturated aqueous NaCl) once (30 ml). The organic solution was dried with MgSO₄, filtered, and concentrated on a rotary evaporator. The crude product was distilled through a column under reduced pressure. Distillation gave 36.53 g of CPMA, yield of 63.8%, b.p. 90.5-92.0° C./5.0 mmHg. The identity of the product was confirmed using ¹H NMR spectroscopy (¹H NMR, CDCl₃/δ: 1.79 (s, 6H, (CH₃H)₂—C(CN)—O—); 3.84 (s, 3H, CH₃—OCOO—).

With the use of the electrolyte Sample No. E-8, two batteries were made in the same manner as described in Example 1. Cycle performance and impedance of the resulting batteries are set forth in Table 2 under the electrolyte Sample No. E-8. As shown in the table the batteries delivered reasonable capacity but showed low rate capability.

### EXAMPLES 9, 10

As summarized in Table 1, these two samples, identified as Sample Nos. E-9 and -10, were prepared with the same formulation as Sample No. E-4 except with a substitution of methoxyacetonitrile “MAN” (Sample No. E-9) or 2-cyanoethyl ether “CEE” (Sample No. E-10) in place of MPN, and also LiBF₄ alone was used for Sample No. E-10 instead of the combination of LiBF₄ and LiPF₆ in the case of Sample No. E-4. Both MAN and CEE were purchased from Sigma-Aldrich Corp. of Milwaukee, Wis., and purified before use by distillation through a column under reduced pressure.

In the same manner as described in Example 1, two batteries were made for each electrolyte samples (Nos. E-9 and -10). Testing data of the resulting batteries are recorded in Table 2 under each electrolyte sample number. As indicated in the table, electrolyte Sample No. E-9 gave great battery performance in terms of capacity, rate capability, and impedance. The batteries made using electrolyte Sample No. E- 10 were charged and discharged very well. However, these batteries showed poor rate capability and also high impedance.

### COMPARATIVE EXAMPLES 3, 4

As summarized in Table 1, Sample Nos. CE-3 and -4, were prepared with the same recipe as Sample No. E-2 except with a substitution of 3-acetoxypropionitrile “APN” (Sample No. CE-3) or 2-cyanoethyl ethyl carbonate “CEEC” (Sample No. CE-4) in place of MPN. Both APN and CEEC were synthesized in-house.

The details for the synthesis of APN is as follows: In a 500-ml flask fitted with a nitrogen inlet and equipped with a magnetic stirrer, were placed 31.99 g (0.45 moles) of 3-hydroxypropionitrile, 250 ml of dichloromethane, and 37.18 g (0.47 moles) of dry pyridine. The flask was cooled to 0-5° C. and 38.86 g (0.495 moles) of acetyl chloride was added in a dropwise manner over about 2 hours under nitrogen atmosphere. Precipitates of pyridine hydrochloride salt formed as acetyl chloride was added. At the conclusion of the addition, the mixture was stirred overnight at room temperature. The mixture was then filtered. The resulting solution was concentrated to about total of 180ml using a rotary evaporator. Then, it was washed with water until the pH of water phase became neutral (four time, 4×50 ml), and finally washed with brine (saturated aqueous NaCl) once (30 ml). The organic solution was dried with MgSO₄, filtered, and concentrated on a rotary evaporator. The crude product was distilled through a column under reduced pressure. Distillation gave 29.01 g of pure APN, b.p. 78.0-81.0° C./4.4 mmHg. The identity of the product was confirmed using ¹H NMR spectroscopy (¹H NMR, CDCl₃/δ: 2.11 (s, 3H, CH₃—COO—); 2.71 (t, 2H, NCCH₂CH₂O—); 4.28 (t, 2H, NCCH₂CH₂O—).

In the same procedure as described above for the synthesis of APN, the CEEC was synthesized as follows:

In a 1000-ml flask fitted with a nitrogen inlet and equipped with a magnetic stirrer, were placed 42.65 g (0.60 moles) of 3-hydroxypropionitrile, 300 ml of dichloromethane, and 50.31 g (0.636 moles) of dry pyridine. The flask was cooled to 0-5° C. and 68.37 g (0.63 moles) of ethyl chloroformate was added in a dropwise manner over about 2 hours under nitrogen atmosphere. Precipitates of pyridine hydrochloride salt formed as ethyl chloroformate was added. At the conclusion of the addition, the mixture was stirred overnight at room temperature. The mixture was then filtered. The resulting solution was concentrated to about total of 200 ml using a rotary evaporator. Then, it was washed with water once (50 ml), then with 5% HCl two times (2×50 ml), and water three times (3×50 ml) until the pH of the water phase became neutral, and finally washed with brine (saturated aqueous NaCl) once (30 ml). The organic solution was dried with MgSO₄, filtered, and concentrated on a rotary evaporator. The crude product was distilled through a column under reduced pressure. Distillation gave 71.10 g of CEEC, yield of 82.8%, b.p. 79.0- 80.5° C./0.31 mmHg. The identity of the product was confirmed using ¹H NMR spectroscopy (¹H NMR, CDCl₃/δ: 1.35 (t, 3H, CH₃—CH₂O—); 2.78 (t, 2H, NCCH₂CH₂—); 4.24 (q, 2H, CH₃CH₂OCO—); 4.33 (t, 2H, NCCH₂CH₂—OCO—).

In the same manner as described in Example 1, two batteries were made for each electrolyte samples. Testing data of the resulting batteries are recorded in Table 2 under each electrolyte Sample Nos. CE-3 and -4. In the both cases, the resulting batteries could not be charged due to a side reaction of electrolyte on electrode. As a result, these batteries delivered very little discharge capacity.

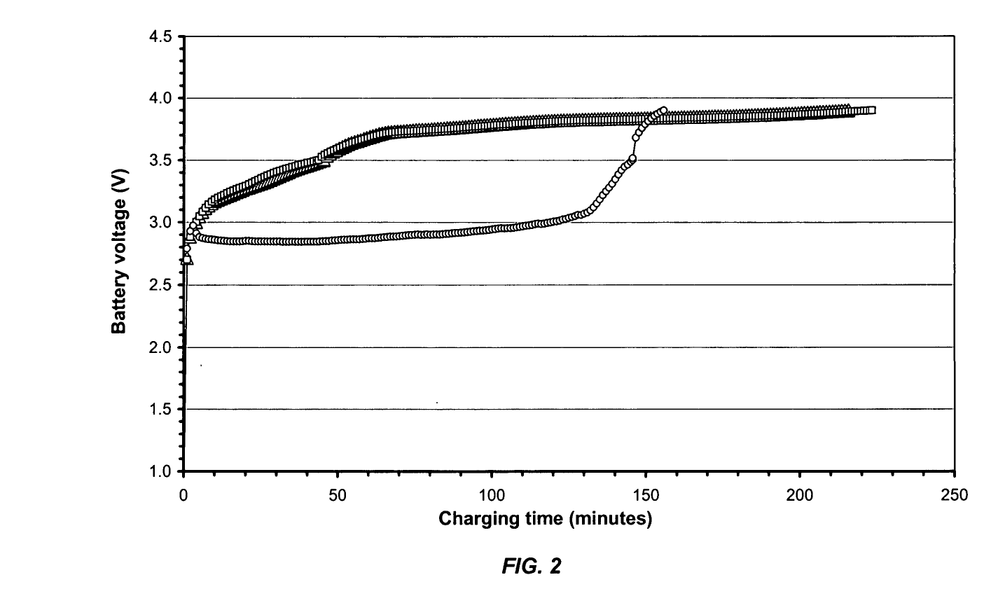

FIG. 2 shows a comparison of voltage profiles of three batteries made using electrolyte Sample Nos. CE-4 (circle), E-2 (triangle), and E-4 (square) during first charge cycle to 3.9V. These three batteries were charged first at a constant current of 3.3 mA to 3.5V, and then at a constant current of 6.6 mA up to 3.9V. As illustrated in the figure, for the batteries made using electrolyte Sample Nos. E-2 and E-4, the battery voltage went up to 3.9V gradually. However, for the battery made using electrolyte Sample No. CE-4, the voltage went up to 3V and then decreased a little and then stayed at a voltage of below 3V for almost 130 minutes and then shut up to 3.9V quickly. It is apparent that some oxidation reaction took place.

These results indicated the electrolyte comprising a nitrile having such chemical structure as APN or CEEC could not be used for high voltage battery e.g. lithium-ion battery since such nitrile is not electrochemically stable.

### COMPARATIVE EXAMPLE 5

This example is shown in Table 1, Sample No. CE-5, which was prepared with the same recipe as Sample No. E-2 except with a substitution of methyl cyanoacetate “MCA” for MPN. The MCA was purchased from Sigma-Aldrich Corp. of Milwaukee, Wis., and purified before use by distillation through a column under reduced pressure.

Two batteries were made using the electrolyte in the same manner as described in Example 1. Testing data of the resulting batteries are recorded in Table 2 under the electrolyte Sample No. CE-5. Both batteries could not be charged or discharged. Capacity as well as rate capability are all zero as indicated in the table. Therefore, the nitrile having such a chemical structure as MCA could not be used to make a non-aqueous electrolyte for high voltage battery e.g. lithium-ion battery.

### EXAMPLES 11-17

As summarized in Table 1, electrolyte Sample No. E-11 was made with the same materials as Sample No. E-4 except the ingredients were present in different weight ratios. Sample Nos. 12 through 17 were prepared with the same recipe as Sample E-4 except without the use of diethyl carbonate “DEC” and also in different ratios.

In the same manner as described in Example 1, two batteries were made for each of the following electrolyte Sample Nos. E-11, E-12, E-15 through -17. Testing data of the resulting batteries are recorded in Table 2 under each electrolyte accordingly.

For all electrolytes except electrolyte Sample No. E-17, the resulting batteries showed excellent performance, fair capacity, high rate capability, and low impedance. In the case of batteries made using electrolyte Sample No. E-17, the capacity and rate capability of the batteries were reduced, indicating the weight ratio 1:19 of ethylene carbonate “EC” to 3-methoxypropionitrile “MPN” was too high.

### COMPARATIVE EXAMPLES 6,7

As summarized in Table 1, Sample Nos. CE-6 and -7, were prepared using the same procedure as described in Example 1 using all conventional materials. The composition of electrolyte Sample No. CE-6 was 1.2M LiPF₆ EC/DEC/DMC (2:1:1), i.e. the concentration of LiPF₆ salt was 1.2M, the weight ratio of solvents ethylene carbonate “EC”/diethyl carbonate “DEC”/dimethyl carbonate “DMC was 2:1:1. While Sample No. CE-7's composition was 1.2M LiPF₆ EC/EMC (1:2), i.e. the concentration of LiPF₆ salt was 1.2M, the weight ratio of solvents EC/ethyl methyl carbonate “EMC” was 1:2. The LiPF₆ salt was produced by Stella Chemifa Corp. of Osaka, Japan, and all solvents were made by Ferro Corp of Zachary, LA.

Two batteries were made using each electrolyte in the same manner as described in Example 1. Testing data of the resulting batteries are recorded in Table 2 under the electrolyte Sample Nos. CE-6 and -7.

TABLE 1

| | | | Wt. % of | | Salt |
|---|---|---|---|---|---|
| | | | nitrile as | | concen- |
| Sample | | Solvents and | of total | Salt molar | tration |
| No. | Nitrile and its structure | wt. ratio | solvents | ratio | (mole) |
| E-1 | 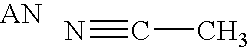 | EC/DEG/AN 2:2:1 | 20.0 | LiBF₄/LiPF_{6 1:0} | 1.2 M |
| CE-1 | 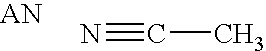 | EC/DEC/AN 1:1:1 | 33.3 | LiBF₄/LiPF_{6 0:1} | 1.2 M |
| E-2 | 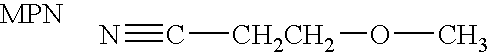 | EC/DEC/MPN 2:2:1 | 20.0 | LiBF₄/LiPF_{6 1:0} | 1.2 M |
| E-3 | 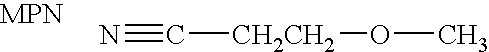 | EC/DEC/MPN 2:2:1 | 20.0 | LiBF₄/LiPF_{6 3:1} | 1.2 M |
| E-4 | 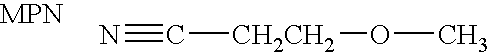 | EC/DEC/MPN 2:2:1 | 20.0 | LiBF₄/LiPF_{6 1:3} | 1.2 M |
| E-5 | 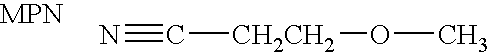 | EC/DEC/MPN 2:2:1 | 20.0 | LiBF₄/LiPF_{6 0:1} | 1.2 M |
| E-6 | 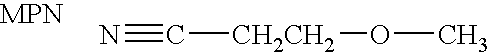 | EC/DEC/MPN 4.5:4.5:1 | 10.0 | LiBF₄/LiPF_{6 1:0} | 2.0 M |
| CE-2 | 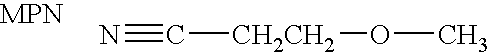 | EC/MPN 0:1 | 100 | LiBF₄/LiPF_{6 1:0} | 1.2 M |
| E-7 | 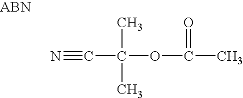 | EC/DEC/ABN 2:2:1 | 20.0 | LiBF₄/LiPF_{6 1:3} | 1.2 M |
| E-8 | 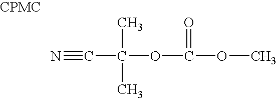 | EC/DEC/CPMC 2:2:1 | 20.0 | LiBF₄/LiPF_{6 1.3} | 1.2 M |
| E-9 | 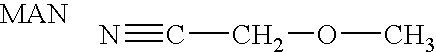 | EC/DEC/MAN 2:2:1 | 20.0 | LiBF₄/LiPF_{6 1.3} | 1.2 M |
| E-10 | 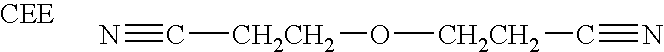 | EC/DEC/CEE 2:2:1 | 20.0 | LiBF₄/LiPF_{6 1.0} | 1.2 M |
| CE-3 | 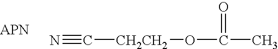 | EC/DEC/APN 2:2:1 | 20.0 | LiBF₄/LiPF_{6 1:0} | 1.2 M |
| CE-4 | 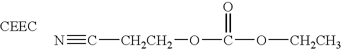 | EC/DEC/ECEC 2:2:1 | 20.0 | LiBF₄/LiPF_{6 1:0} | 1.2 M |
| CE-5 | 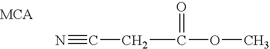 | EC/DEC/MCA 2:2:1 | 20.0 | LiBF₄/LiPF_{6 1:0} | 1.2 M |
| E-11 | 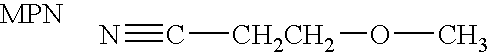 | EC/DEC/MPN 2:1:1 | 25.0 | LiBF₄/LiPF_{6 1:3} | 1.2 M |
| E-12 | 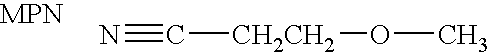 | EC/MPN 1:1 | 50.0 | LiBF₄/LiPF_{6 1:3} | 1.2 M |
| E-13 | 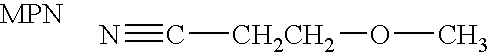 | EC/MPN 1:2 | 66.7 | LiBF₄/LiPF_{6 1:3} | 1.2 M |
| E-14 | 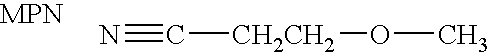 | EG/MPN 1:3 | 75.0 | LiBF₄/LiPF_{6 1:3} | 1.2 M |
| E-15 | 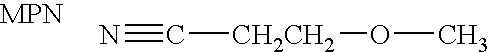 | EC/MPN 1:4 | 80.0 | LiBF₄/LiPF_{6 1:3} | 1.2 M |
| E-16 | 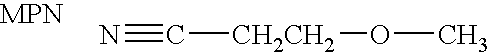 | EC/MPN 1:9 | 90.0 | LiBF₄/LiPF_{6 1:3} | 1.2 M |
| E-17 | 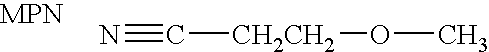 | EC/MPN 1:19 | 95.0 | LiBF₄/LiPF_{6 1:3} | 1.2 M |
| CE-6 | none | EC/DEC/DMC | 0 | LiBF₄/LiPF₆ | 1.2 M |
| | | 2:1:1 | | 0:1 | |
| CE-7 | none | EC/EMC | 0 | LiBF₄/LiPF₆ | 1.2 M |
| | | 1:2 | | 0:1 | |

In Table 1, the abbreviations are as follows: EC, ethylene carbonate; DEC, diethyl carbonate; AN, acetonitrile; MPN, 3-methoxypropionitrile; ABN, 2-acetoxyisobutyronitrile; CPMC, 2-cyanoisopropyl methyl carbonate; MAN, methoxyacetonitrile; CEE, 2-cyanoethyl ether; APN, 3-acetoxypropionitrile; CEEC, 2-cyanoethyl ethyl carbonate; MCA, methyl cyanoacetate; EMC, ethyl methyl carbonate.

TABLE 2

| | Discharge | | | | |
|---|---|---|---|---|---|
| Electrolyte | capacity | Rate capability (%) | | AC impedance (ohm) | |
| Sample No. | (mAh) | at 1 C rate | at 2 C rate | Re | Rp |
| E-1 | 35.59 | 97.2 | 89.6 | 0.772 | 2.665 |
| | 35.46 | 97.7 | 90.7 | 0.722 | 2.120 |
| CE-1 | 1.82 | 16.5 | 4.7 | 5.181 | 56.397 |
| | 4.57 | 18.4 | 6.5 | 1.368 | 16.738 |
| E-2 | 33.07 | 97.5 | 59.8 | 0.941 | 2.313 |
| | 33.31 | 96.4 | 53.2 | 0.967 | 2.104 |
| E-3 | 33.52 | 98.2 | 66.6 | 0.678 | 1.880 |
| | 33.09 | 97.9 | 73.5 | 0.636 | 1.755 |
| E-4 | 33.33 | 98.6 | 87.8 | 0.522 | 1.465 |
| | 33.45 | 97.9 | 78.3 | 0.560 | 1.382 |
| E-5 | 32.21 | 98.0 | 88.4 | 0.545 | 2.481 |
| | 33.15 | 97.6 | 78.8 | 0.547 | 2.393 |
| E-6 | 33.31 | 97.6 | 66.0 | 1.130 | 2.250 |
| | 33.17 | 98.6 | 69.9 | 0.890 | 2.273 |
| CE-2 | 0.00 | 0.0 | 0.0 | 2.076 | |
| | 0.00 | 0.0 | 0.0 | 2.129 | |
| E-7 | 35.49 | 94.0 | 46.9 | 0.698 | 2.988 |
| | 33.81 | 97.3 | 46.6 | 0.653 | 2.915 |
| E-8 | 33.44 | 93.6 | 42.8 | 0.744 | 4.209 |
| | 34.11 | 93.0 | 43.0 | 0.714 | 3.579 |
| E-9 | 35.74 | 97.3 | 88.0 | 0.551 | 2.627 |
| | 35.73 | 96.8 | 83.0 | 0.573 | 2.496 |
| E-10 | 31.43 | 89.7 | 36.2 | 1.018 | 3.104 |
| | 31.46 | 92.3 | 36.3 | 1.021 | 3.026 |
| CE-3 | 1.97 | 14.1 | 1.6 | 1.712 | 8.323 |
| | 3.67 | 26.2 | 7.4 | 1.605 | 7.172 |
| CE-4 | 4.14 | 26.2 | 9.0 | 2.357 | 5.902 |
| | 3.85 | 28.7 | 9.2 | 1.808 | 4.548 |
| CE-5 | 0.00 | 0.0 | 0.0 | 2.096 | |
| | 0.00 | 0.0 | 0.0 | 2.354 | |
| E-11 | 33.48 | 98.3 | 91.3 | 0.457 | 1.482 |
| | 33.89 | 98.0 | 91.8 | 0.481 | 1.558 |
| E-12 | 33.88 | 96.9 | 90.8 | 0.527 | 1.585 |
| | 34.12 | 97.3 | 85.6 | 0.625 | 1.614 |
| E-15 | 34.82 | 97.8 | 96.2 | 0.507 | 2.380 |
| | 34.94 | 97.6 | 95.9 | 0.522 | 2.487 |
| E-16 | 35.25 | 96.9 | 87.9 | 0.472 | 2.750 |
| | 34.87 | 96.3 | 83.0 | 0.456 | 2.919 |
| E-17 | 26.44 | 62.5 | 13.3 | 0.768 | 4.410 |
| | 25.10 | 47.1 | 10.4 | 1.059 | 4.498 |
| CE-6 | 34.98 | 98.0 | 90.7 | 0.517 | 2.036 |
| | 35.51 | 97.6 | 90.8 | 0.550 | 1.989 |
| CE-7 | 37.62 | 96.0 | 93.6 | 0.422 | 1.905 |
| | 37.21 | 96.7 | 94.8 | 0.432 | 1.813 |

### EXAMPLE 18

### Ionic Conductivities of Electrolytes

Non-aqueous electrolyte samples were prepared in the manner as described in Example 1. Then, the ionic conductivities of electrolytes were measured at various temperatures. The measurement was conducted through AC impedance measurement by scanning from 500 kHz to 0.5 Hz. Recorded in Table 3, are data concerning eleven electrolytes comprising at least a nitrile. Conductivity data of electrolyte Sample Nos. CE-6 and -7, which were made using all conventional materials, are also included in the table for comparison as control.

As shown in the table, the ionic conductivities of electrolytes, which is related to the chemical structure of nitrile, vary in a range from 3.97 to 9.55 S/cm at 25° C., and 0.72˜2.78 at −20° C.

Electrolyte Sample Nos. E-15 through E-17 which comprises 3-methoxypropionitrile “MPN” showed higher ionic conductivity than conventional electrolytes (Sample Nos. CE-6 and -7). In particular, at low temperature of −20° C., the conductivities of these three electrolytes are 2.34, 2.61, and 2.78 S/cm respectively which are better than control electrolyte Sample Nos. CE-6 and -7.

TABLE 3

| | |
|---|---|
| | Ionic conductivity |
| | at various |
| Electrolyte | temperatures (mS/cm) |

| Sample No. | 25° C. | −20° C. |
|---|---|---|
| E-2 | 3.97 | |
| E-3 | 5.10 | 1.46 |
| E-4 | 7.60 | 1.88 |
| E-5 | 8.60 | 2.02 |
| E-7 | 5.29 | 0.95 |
| E-8 | 4.80 | 0.72 |
| E-11 | 8.15 | 2.02 |
| E-12 | 8.79 | 1.89 |
| E-15 | 9.17 | 2.34 |
| E-16 | 9.53 | 2.61 |
| E-17 | 9.37 | 2.78 |
| CE-6 | 9.55 | 1.88 |
| (control) | | |
| CE-7 | 9.06 | 2.15 |
| (control) | | |

### EXAMPLE 19

### Electrolyte Performance at Low as Well as at High Temperature

Table 4 gives a summary of freezing points and weight loss at 90° C. for various electrolytes. These electrolytes are Sample Nos. E-2 through 5, E-10, E-13, E-14, CE-2, CE-4 and -5, and two control electrolytes CE-6 and -7.

The freezing point of electrolyte was determined by cooling electrolyte sample at a low temperature for 2 hours, then recording the appearance of electrolyte. For instance, if a liquid electrolyte became a solid state after it was cooled at −40° C. for two hours. Then, the freezing point of this electrolyte was recorded as −40° C. The order of cooling temperature was −20° C. first, and the −30, −40, −50, and −60° C.

In the point of view of ionic conductivity, the lower freezing point the better since solid state generally gives a much lower conductivity due to reduced mobility of ions. As shown in the table, the freezing points of both control electrolyte Sample Nos. CE-6 and CE-7 are -40 and −60° C. respectively. However, most of the electrolyte made with nitrile showed lower freezing point, less than −60° C. They are electrolyte Sample Nos. E-4, E-5, CE-2, E-10, E-13, and E-14. Therefore, the electrolytes comprising at least a nitrile compound showed an extended low-temperature limit for battery applications.

The commercial lithium-ion batteries could be used in a temperature rang of from −20° C. to +60° C. However, both consumer and specialty markets of batteries have a trend towards wider temperature range for applications, namely, lower low-temperature limit and higher high-temperature limit.

In the case of commercial lithium-ion batteries, the high-temperature is limited to 60° C. because some electrolyte components have very low boiling point or high vapor pressure at an elevated temperature, for instance, the boiling point of dimethyl carbonate “DMC” is only 90° C., and ethyl methyl carbonate “EMC” 109° C.

To increase the high-temperature limit, the boiling point of solvent must be raised. Table 4 also gives a summary of weight loss at high temperature of 90° C. for various electrolytes. The lower vapor pressure of electrolyte 90° C. the lower weight loss, and the higher high-temperature limit for applications.

As shown in the table, the weight loss of both control electrolyte Sample Nos. CE-6 and CE-7 are 21.5 and 33.9% respectively after stored at 90° C. for 4 hours. However, the other electrolytes made with the use of nitrile showed much less weight loss. The weigh losses are 3.8 and 4.2% for the electrolyte Sample Nos. E-13 and E-14 respectively after they were heated at a temperature of 90° C. for 4 hours.

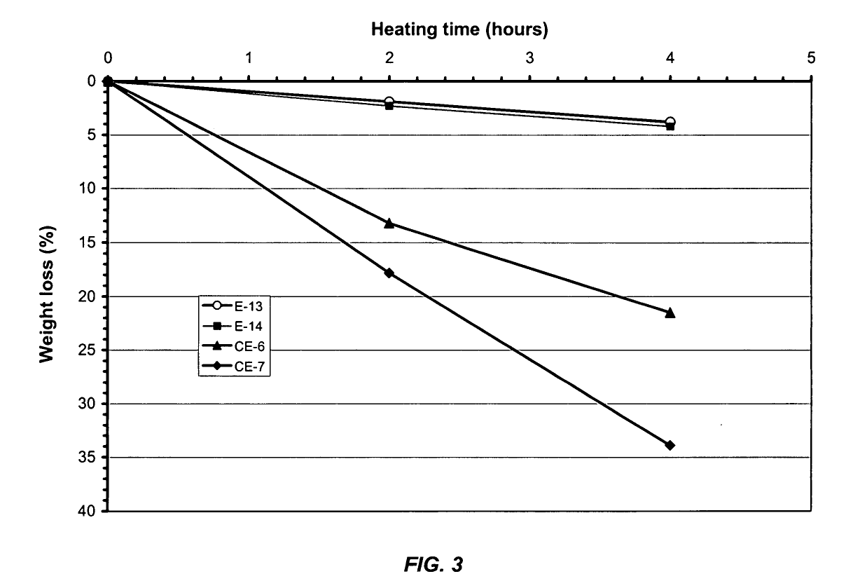

FIG. 3 shows a comparison of weight loss at 90° C. for the electrolytes of the present invention Sample Nos. E-13, -14 and control electrolytes Sample Nos. CE-6 and -7. It is clear that the electrolytes of the present invention have showed low vapor pressure at high temperature of 90° C., namely they have an increased high-temperature limit for battery applications.

TABLE 4
Freezing and weight loss at high temperature of various electrolytes

| | | |
|---|---|---|
| | Freezing | |
| Electrolyte | point | Weight loss (%) |

| sample No. | (° C.) | 90° C. for 2 h | 90° C. for 4 h |
|---|---|---|---|
| E-2 | −40 | 6.5 | 12.1 |
| E-3 | −50 | 6.3 | 11.7 |
| E-4 | <−60 | 6.1 | 11.4 |
| E-5 | <−60 | 6.0 | 11.4 |
| CE-2 | <−60 | 2.5 | 4.8 |
| E-10 | <−60 | 6.7 | 12.5 |
| E-13 | <−60 | 1.9 | 3.8 |
| E-14 | <−60 | 2.3 | 4.2 |
| CE-4 | −60 | 6.4 | 11.6 |
| CE-5 | −40 | 5.8 | 11.0 |
| CE-6 | −40 | 13.2 | 21.5 |
| (control) | | | |
| CE-7 | −60 | 17.8 | 33.9 |
| (control) | | | |

### EXAMPLE 20

### Concentration of Nitrile

Table 5 shows the relationship between the concentration of nitriles and the ionic conductivity of the resulting electrolytes as well as the rate capability at 2 C rate of the resulting batteries. The rate capability at 2 C rate is the percentage of discharge capacity obtained when the battery was discharged at a high rate of 2.0 C compared to the capacity obtained at 0.2 C.

It is apparent that the ionic conductivity of electrolyte is proportional to the concentration of nitrile. When the nitrile is present in an amount of from 25 to 90% by weight or 29.6 to 92.7% by volume, the resulting electrolyte shows higher conductivity and also better battery performance. For example, the electrolyte Sample No. E-11 containing 25 wt. % nitrile (or 29.6 vol. %) shows a conductivity of 8.15 mS/cm at 25° C., which is higher than the electrolyte Sample No. E-4 which comprises only 20 wt. % nitrile (or 23.0 vol. %), 7.60 mS/cm. The 2 C-rate capability of the batteries made using the former electrolyte is also higher (91.3, 91.8%) than the batteries made using the latter electrolyte (87.8, 78.3%).

TABLE 5

| | | | Conductivity at | | |
|---|---|---|---|---|---|
| | | | various | | |
| Electrolyte | Wt. % of | Vol. % of | temperatures | | Rate |
| Sample | nitrile as of | nitrile as of | (mS/cm) | | capability at |
| No. | total solvents | total solvents | 25° C. | −20° C. | 2 C (%) |
| E-4 | 20 | 23.0 | 7.60 | 1.88 | 87.8 |
| | | | | | 78.3 |
| E-11 | 25 | 29.6 | 8.15 | 2.02 | 91.3 |
| | | | | | 91.8 |
| E-12 | 50 | 58.5 | 8.88 | 1.94 | 90.8 |
| | | | | | 85.6 |
| E-15 | 80 | 84.9 | 9.17 | 2.34 | 96.2 |
| | | | | | 95.9 |
| E-16 | 90 | 92.7 | 9.53 | 2.61 | 87.9 |
| | | | | | 83.0 |
| E-17 | 95 | 96.4 | 9.37 | 2.78 | 13.3 |
| | | | | | 10.4 |

### EXAMPLE 21

### Batteries and Their Performance

A larger sized lithium-ion rechargeable battery, Battery No. 1, was prepared using the electrolyte of the present invention Sample No. E-14 and using same electrodes and separator membrane as described in Example 1.

Fourteen pieces of microporous membranes of with a dimension of 35 mm by 56 mm were inserted between 7 pieces of positive electrodes with a dimension of 31 mm by 51 mm and 8 pieces of negative electrodes with a dimension of 33 mm by 53 mm, i.e. the battery having a total active area of 221.3 cm². The assembled battery cell was then packaged and partially sealed in an aluminum pre-formed foil-laminated plastic battery case. After the battery was fully dried, it was transferred into a dry-box under nitrogen. Then, into the battery was injected substantially 2.75 g of the electrolyte Sample No. E-14 which comprises 1.2M LiBF₄/LiPF₆ in a molar ratio of 1:3, and ethylene carbonate “EC” and 3-methoxypropionitrile “MPN” in a 1:3 weight ratio. The battery was hermetically sealed. The battery was then subjected to charge/discharge cycle test and then temperature performance test by discharging the battery at various temperatures.

The temperature performance test was carried out as follows: after fully charged at room temperature about 23-25° C., the battery was then placed in a refrigerator with a stabilized temperature of −30° C. Then rested for 60 minutes to allow the temperature reach an equilibrium. The battery was then discharged at a constant current of 130 mA, i.e. 0.2 C rate, to a cut off voltage of 2.75V. Testing data of the battery are recorded in Table 6 as Battery No. 1.

A second battery was prepared in the same manner as described above for Battery No. 1 except with a substitution of electrolyte Sample No. E-9 in place of Sample No. E-14. Testing data of the resulting battery are recorded in Table 6 as Battery No. 2.

For comparison, other two batteries were made in the same way as described above for Battery No. 1 except with a substitution of electrolyte Sample Nos. CE-6 and -7 for electrolyte Sample No. E-14 as Battery Nos. 3 and 4 (control battery). Both electrolytes Sample Nos. CE-6 and -7 were prepared using conventional electrolyte materials. Testing data on these two control batteries are also recorded in Table 6 as Battery Nos. 3 and 4.

As summarized in Table 6, both Battery Nos. 1 and 2 delivered greater discharge capacity at −30° C. than other two control batteries. The capacity retention when discharged at −30° C. vs. at +25° C. was 63.6 and 60.7% respectively for Battery Nos. 1 and 2, which is also better than other two control batteries (53.5, and 25.8%).

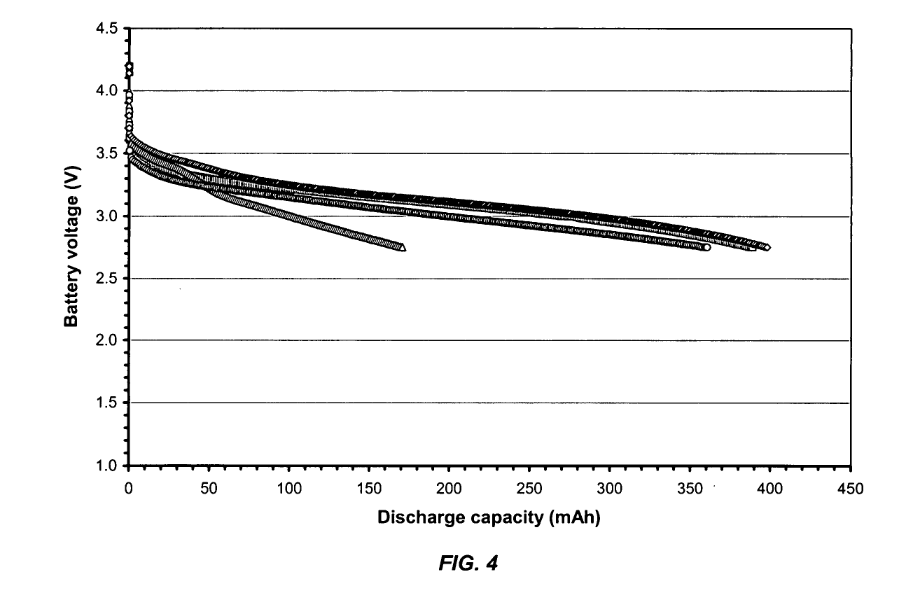

FIG. 4 shows discharge profiles at −30° C. of four batteries made with the use of the electrolyte of the present invention Sample Nos. E-14 (Battery No. 1, square) and E-9 (Battery No. 2, diamond), and two control conventional electrolytes Sample Nos. CE-6 (Battery No. 3, triangle) and CE-7 (Battery No. 4, circle).

It is apparent that batteries made using the electrolyte of the present invention demonstrated better performance at the low temperature of −30° C.

TABLE 6

| | | | Capacity |
|---|---|---|---|
| | | Discharge capacity | retention (%): |
| | Electrolyte | at −30° C. | (at −30° C. vs. at |
| Battery No. | sample No. | (mAh) | 25° C.) |
| Battery No. 1 | E-14 | 388.63 | 63.6 |
| Battery No. 2 | E-9 | 397.86 | 60.7 |
| Battery No. 3 | CE-6 | 360.35 | 53.5 |
| (control) | | | |
| Battery No. 4 | CE-7 | 170.64 | 25.8 |
| (control) | | | |

1. A non-aqueous electrolyte, comprising: (1) at least one electrolyte salt selected from the group consisting of LiPF₆, LiBF₄, LiAsF₆, LiCl₄, LiN(SO₂CF₃)₂, and a lithium perfluoro-sulfonate, (2) a first non-aqueous solvent selected from the group consisting of at least one cyclic carbonate, linear carbonate, ester, and ether, and (3) a second non-aqueous solvent being at least one of the nitrile compounds represented by the following general formula (I) and (II): 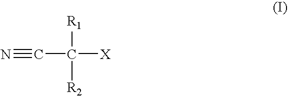
wherein R₁, R₂ are selected, independent of one another, from the group consisting of hydrogen, C₁₋₃ alkyl, fluorinated C₁₋₃ alkyl groups; wherein X is selected from ether radical having a chemical structure of —O—R₃, ester radical having a chemical structure of 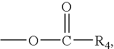
and carbonate radical having a chemical structure of 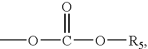
wherein R₃, R₄, R₅ are selected, independent of one another, from the group consisting of C₁₋₃ alkyl and fluorinated C₁₋₃ alkyl, and 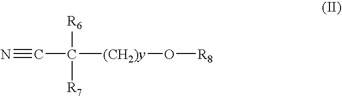
wherein R₆, R₇ are selected, independent of one another, from the group consisting of hydrogen, C₁₋₃ alkyl, fluorinated C₁₋₃ alkyl groups; Y stands an integer of 1 and 2; R₈ is selected from the group consisting of C₁₋₃ alkyl and fluorinated C₁₋₃ alkyl,
wherein the second solvent is present in an amount of from about 20 to about 95% by weight as of the total of non-aqueous solvents.

2. The non-aqueous electrolyte of claim 1, wherein said electrolyte salt is a mixture of LiPF₆ and LiBF₄ in a molar ratio from about 90:10 to about 50:50.

3. The non-aqueous electrolyte of claim 1, wherein the first solvent is present in an amount of from about 5 to about 80 by weight as of the total of non-aqueous solvents.

4. The non-aqueous electrolyte of claim 1, wherein the second non-aqueous solvent is selected from the group consisting of 3-methoxypropionitrile, 3-ethoxypropionitrile, methoxyacetonitrile, ethoxyacetonitrle, 2-acetoxyisobutyronitrile, 2-cyanoisopropyl methyl carbonate, 2-acetoxyacetonitrile, 2-acetoxyisopropionitrile, cyanomethyl methyl carbonate, and 1-cyanoethyl methyl carbonate.

5. The non-aqueous electrolyte of claim 1, wherein the second non-aqueous solvent is present in an amount of from about 25 to about 80% by weight as of the total of non-aqueous solvents.

6. The non-aqueous electrolyte of claim 1, wherein the second non-aqueous solvent is present in an amount of from about 30 to about 50% by weight as of the total of non-aqueous solvents.

7. A non-aqueous electrolyte comprising: (1) electrolyte salt containing LiPF₆ and LiBF₄ in a molar ratio from about 90:10 to about 50:50, (2) a first non-aqueous solvent selected from the group consisting of ethylene carbonate, propylene carbonate, diethyl carbonate, dimethyl carbonate, and ethyl methyl carbonate, and (3) a second non-aqueous solvent selected from the group consisting of 3-methoxypropionitrile, 3-ethoxypropionitrile, methoxy acetonitrile, ethoxyacetonitrle, 2-acetoxyisobutyronitrile, 2-cyanoisopropyl methyl carbonate, 2-acetoxyacetonitrile, 2-acetoxyisopropionitrile, cyanomethyl methyl carbonate, and 1-cyanoethyl methyl carbonate.

8. The non-aqueous electrolyte of claim 1, wherein the ionic conductivity of said electrolyte is greater than 9×10⁻³ S/cm at about 25° C.

9. The non-aqueous electrolyte of claim 1, wherein the ionic conductivity of said electrolyte is greater than 1×10⁻³ S/cm at about −30° C.

10. The non-aqueous electrolyte of claim 1, wherein the ionic conductivity of said electrolyte is greater than 3×10⁻⁴ S/cm at about −50° C.

11. The non-aqueous electrolyte of claim 1, wherein the weight loss of said electrolyte is less than 3% after heated at 90° C. for 2 hours.

12. The non-aqueous electrolyte of claim 1, wherein the weight loss of said electrolyte is less than 5% after heated at 90° C. for 4 hours.

13. The non-aqueous electrolyte of claim 1, wherein the freezing point of said electrolyte is less than −60° C.

14. The non-aqueous electrolyte of claim 1, wherein the boiling point of said nitrile is higher than 120° C.

15. The non-aqueous electrolyte of claim 1, wherein the flash point of said nitrile is higher than 60° C.

16. The non-aqueous electrolyte of claim 1, wherein the molecular weight of said nitrile is smaller than 90.

17. A lithium-ion battery comprising (1) at least one positive electrode made of lithiated metal oxide selected from the group consisting of LiCoO₂, LiNiO₂, LiMn₂O₄, LiFePO₄, and LiCoₓNi₁₋ₓO₂ wherein the x is from 0.1 to 0.9, (2) at least one negative electrode made of carbonaceous material selected from the group consisting of coke and graphite, (3) a separator membrane, and (4) a non-aqueous electrolyte which comprises (i) an electrolyte salt, (ii) a first non-aqueous solvent, and (iii) a second non-aqueous solvent being at least one of the nitrile compounds represented by the following general formula (I) and (II): 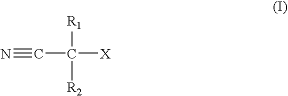
wherein R₁, R₂ are selected, independent of one another, from the group consisting of hydrogen, C₁₋₃ alkyl, fluorinated C₁₋₃ alkyl groups; wherein X is selected from ether radical having a chemical structure of —O—R₃, ester radical having a chemical structure of 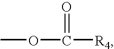
and carbonate radical having a chemical structure of 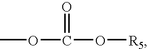
wherein R₃, R₄, R₅ are selected, independent of one another, from the group consisting of C₁₋₃ alkyl and fluorinated C₁₋₃ alkyl, and 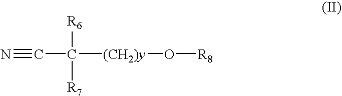
wherein R₆, R₇ are selected, independent of one another, from the group consisting of hydrogen, C₁₋₃ alkyl, fluorinated C₁₋₃ alkyl groups; Y stands an integer of 1 and 2; R₈ is selected from the group consisting of C₁₋₃ alkyl and fluorinated C₁₋₃ alkyl,
wherein the second solvent is present in an amount of from about 20 to about 95% by weight as of the total of non-aqueous solvents.

18. The lithium-ion battery of claim 17, wherein said electrolyte salt comprises a cation and an anion, said cation being selected from the group consisting of lithium ion, sodium ion and potassium ion, and said anion being selected from the group consisting of anions of halides of elements of the groups IIIa and Va of the periodic table, halogen anions, and perchloric acid anions.

19. The lithium-ion battery of claim 17, wherein said electrolyte salt is selected from the group consisting of LiPF₆, LiBF₄, LiAsF₆, LiCl₄, LiN(SO₂CF₃)₂, lithium perfluoro-sulfonates, and combination thereof.

20. The lithium-ion battery of claim 17, wherein said first non-aqueous solvent is selected from the group consisting of cyclic carbonate, linear carbonate, ester, ether and combination thereof.

21. A lithium-ion battery comprising (1) at least one lithium-ion positive electrode (2) at least one lithium-ion negative electrode (3) a separator membrane, and (4) a non-aqueous electrolyte comprising: (i) electrolyte salt containing LiPF₆ and LiBF₄ in a molar ratio from about 90:10 to about 50:50, (ii) a first non-aqueous solvent selected from the group consisting of ethylene carbonate, propylene carbonate, diethyl carbonate, dimethyl carbonate, and ethyl methyl carbonate, and (iii) a second non-aqueous solvent selected from the group consisting of 3-methoxypropionitrile, 3-ethoxypropionitrile, methoxy acetonitrile, ethoxyacetonitrle, 2-acetoxyisobutyronitrile, 2-cyanoisopropyl methyl carbonate, 2-acetoxyacetonitrile, 2-acetoxyisopropionitrile, cyanomethyl methyl carbonate, and 1-cyanoethyl methyl carbonate, wherein the first solvent is present in an amount of from about 5 to about 80% by weight as of the total of non-aqueous solvents, the second solvent is present in an amount of from about 20 to about 95% by weight as of the total of non-aqueous solvents.

22. A method of making a lithium-ion battery of claim 17, comprising the steps of (a) assembling battery by sandwiching at lease a separator membrane between at least a positive electrode and at least a negative electrode, (b) packaging the assembled battery cell into a battery case, (c) preparing non-aqueous electrolyte of claim 1, and (d) adding the non-aqueous electrolyte into the battery case.
